(19) United States
(12) Patent Application Publication
(10) Pub. No.: US 2024/0160038 A1
(43) Pub. Date: May 16, 2024

(54) EYEGLASS LENS FOR PREVENTING AND CONTROLLING MYOPIA

(71) Applicant: Jangsu Conant optical Co.,Ltd, Nantong (CN)

(72) Inventors: Hongbin Fan, Nantong (CN); Chuanbao Wang, Nantong (CN)

(21) Appl. No.: 18/086,658

(22) Filed: Dec. 22, 2022

(30) Foreign Application Priority Data
Nov. 14, 2022 (CN) 202211418877.3

(51) Int. Cl. G02C 7/02

(52) U.S. Cl. CPC G02C 7/02; G02C 2202/24

(57) ABSTRACT

Disclosed in the present disclosure is an eyeglass lens for preventing and controlling myopia. The eyeglass lens includes a lens body, the lens body includes a first area, a second area, and third areas, the first area is a regular area formed with an optical centre of the lens body as a centre, the first area has a refractive power with a myopia correction function, the second area is a peripheral area of the lens body, and the second area is used for focusing an image on a position in front of a retina of an eye, to inhibit myopia development of the eye. The present disclosure has a simple structure and rational design, when a patient views an object with the eyeglass lens for preventing and controlling myopia, an image is formed on the retina, meanwhile, an image is formed in front of the retina, and a contrast of imaging at the periphery of the retina is reduced, such that the eyeglass lens has a function of inhibiting or at least slowing down development of myopia of a human eye, and a machining cost can be effectively controlled, to facilitate promotion and popularization of vision protective lenses.

### TECHNICAL FIELD

The present disclosure relates to the technical field of eyeglass lenses, in particular to an eyeglass lens for preventing and controlling myopia.

### BACKGROUND ART

With the popularization of electronics, the problem of poor vision in adolescents is increasingly serious, myopia is moving towards younger age, vision control allows of no delay, so called myopia is projection of an image in front of a retina, and a method for correcting vision is to wear myopic glasses to correct the projection of visual image onto the retina.

Myopia of an eye is characterized by the eye focusing a distant object in front of its retina, and is usually corrected using a concave lens, and when a conventional single-vision optical lens is used to correct myopia, the central portion of the image is transmitted on the retina, but its peripheral portion is transmitted behind the retina, inducing growth of an eyeball to a position behind the retina, an ocular axis increases, and a refractive state of the eye progresses towards deepening of myopia.

The prior art has the deficiencies:
as for vision control lenses, the foreign patents involve a lens described in Japan patent application No. 44891249, which is a concentric Fresnel multifocal lens, the domestic patents involve CN104678572B and CN11390809A, etc., these patents generally correct a vision refractive error by means of a first area and add a positive refractive power to the first area by means of a second region so as to transmit the peripheral portion of the image in front of the retina, thereby having a function of inhibiting or at least slowing down development of myopia; and
the lenses of these domestic patents are difficult to process, costly to process, and thus expensive to sell, which is not conducive to the promotion and popularization of vision control lenses.

### SUMMARY

The objective of the present disclosure is to provide an eyeglass lens for preventing and controlling myopia, to solve the problems in the background.

In order to achieve the above objective, the present disclosure provides the following technical solution: an eyeglass lens for preventing and controlling myopia includes a lens body, where the lens body includes:
a first area, the first area being a regular area formed with an optical centre of the lens body as a centre, and the first area having a refractive power with a myopia correction function;
a second area, the second area being a peripheral area of the lens body, and the second area being used for focusing an image on a position in front of a retina of an eye, to inhibit myopia development of the eye; and
third areas, the third areas being a plurality of island-shaped areas separate from one another on a portion of the lens body between the first area and the second area, and the third areas being used for cutting off or scattering light passing through the areas so as to reduce a contrast of a retinal image, to inhibit a refractive error of the eye.

As a further improvement of the present disclosure, each separate island-shaped area of the third areas is in a symmetrical shape, the symmetrical shape includes a circular shape, a square shape and a regular hexagon shape, each separate island-shaped area of the third areas has a diameter of 0.1 mm-2.0 mm, and spacing between adjacent separate island-shaped areas is 0.1 mm-3.0 mm.

As a further improvement of the present disclosure, the third areas are formed at a front surface or a rear surface of the lens body, the third areas form a regular area having the optical centre of the lens body as a centre and having a diameter of 5.0 mm-22 mm, and the regular area formed by the third areas includes a circular shape, a shell shape, a triangle shape, a square shape and a regular hexagon shape.

As a further improvement of the present disclosure, the third areas cut off or scatter light by reducing a degree of finish of a surface so as to reduce the contrast of imaging on the retina.

As a further improvement of the present disclosure, an area of the third areas is 10%-80% of a sum of areas of the second area and the third areas.

As a further improvement of the present disclosure, refractive powers of the first area and the second area vary through the optical centre of the lens body continuously and radially.

As a further improvement of the present disclosure, the first area and the second area obtain different refractive powers by forming different surface shapes.

As a further improvement of the present disclosure, the first area and the second area include a front surface and a rear surface of the lens body, either one or both of the front surface and the rear surface are free-form surfaces, either one or both of the front surface and the rear surface include a horizontal meridian and a vertical meridian, and the first area and the second area form areas including:
a central area used for providing a positive refractive power for myopia correction; and
a peripheral area comprising a progressive area symmetrically distributed on two sides of the vertical meridian and radiating outward from the central area.

As a further improvement of the present disclosure, the first area and the second area form an area having a feature point offset from the optical centre of the lens body along a horizontal meridian by 20 mm, and the feature point has an additional refractive power of a refractive power being 0.40 D-2.00 D with respect to a correcting refractive power.

As a further improvement of the present disclosure, the second area has an additional refractive power with respect to the first area for focusing the image on the position in front of the retina of the eye, to inhibit myopia development of the eye.

Compared with the prior art, the present disclosure has the following beneficial effects:
The lens body of the present disclosure includes a first area, a second area and a third area, the first area has a function of focusing an image on a retina of an eye, the second area has a function of focusing the image at a position in front of the retina, the third area has a function of reducing a contrast of imaging at the periphery of the retina, while an image of an object formed in the first area is visually distinguished, development of myopia is inhibited or at least slowed down by limiting imaging in front of the retina by the second area, and the development of myopia is further inhibited or at least slowed down by reducing a contrast of imaging at the periphery of the retina by the third area. When a patient views an object with the eyeglass lens for preventing and controlling myopia, an image is formed on a retina, meanwhile, an image is formed in front of the retina, and a contrast of imaging at the periphery of the retina is reduced.

### BRIEF DESCRIPTION OF THE DRAWINGS

FIG. 1 is a schematic diagram of an overall structure according to Example 1 of the present disclosure;

FIG. 2 is a schematic diagram of third areas according to Example 1 of the present disclosure;

FIG. 3 is a schematic diagram of light with an arc front surface and an art rear surface according to Example 1 of the present disclosure;

FIG. 4 is a schematic diagram of light with an arc front surface according to Example 1 of the present disclosure;

FIG. 5 is a schematic diagram of an overall structure according to Example 2 of the present disclosure;

FIG. 6 is a schematic diagram of third areas according to Example 2 of the present disclosure;

FIG. 7 is a schematic diagram of light with an arc front surface and an art rear surface according to Example 2 of the present disclosure; and

FIG. 8 is a schematic diagram of light with an arc front surface according to Example 2 of the present disclosure.

In the figures: 1. lens body; 101. first area; 102. second area; and 103. third area.

### DETAILED DESCRIPTION OF THE EMBODIMENTS

In order to make the technical problem to be solved by the present disclosure, the solution and the beneficial effect more clear, the present disclosure will be described in further detail below in conjunction with the accompanying drawings and examples. It should be understood that the specific examples described herein are merely illustrative of the present disclosure and are not intended to limit the present disclosure.

It is to be noted that when an element is referred to as being “fixed on”, “mounted on”, “connected to” or “provided with” another element, it can be directly on another element or indirectly on another element. It is to be understood that the terms “upper”, “lower”, “front”, “back”, “left”, “right”, “vertical”, “horizontal”, “top”, “bottom”, “inner”, “outer”, etc. indicate azimuthal or positional relations based on those shown in the drawings only for ease of description of the present disclosure and for simplicity of description, and are not intended to indicate or imply that the referenced device or element must have a particular orientation of the specification and be constructed and operative in a particular orientation, and thus may not be construed as a limitation on the present disclosure.

As a further improvement in the present disclosure, the terms “first”, “second”, “third”, etc. are merely used for describing purposes and cannot be understood as indicating or implying relative importance implicitly indicating the number of indicated technical features. Therefore, the features defined with “first” and “second” can explicitly or implicitly include one or more features.

### Example 1

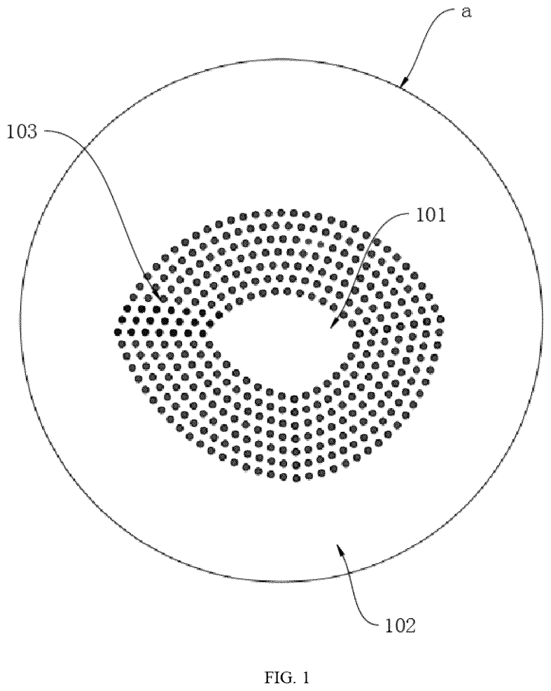

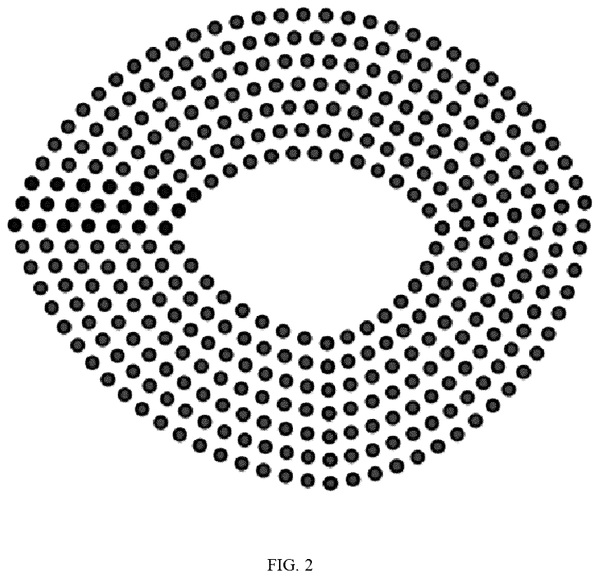

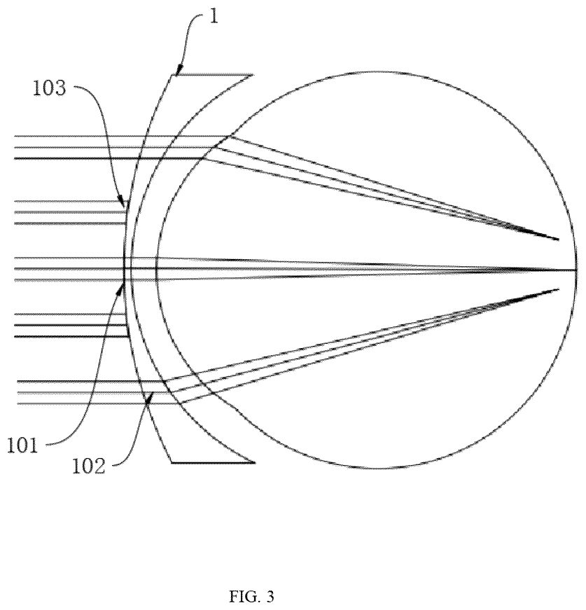

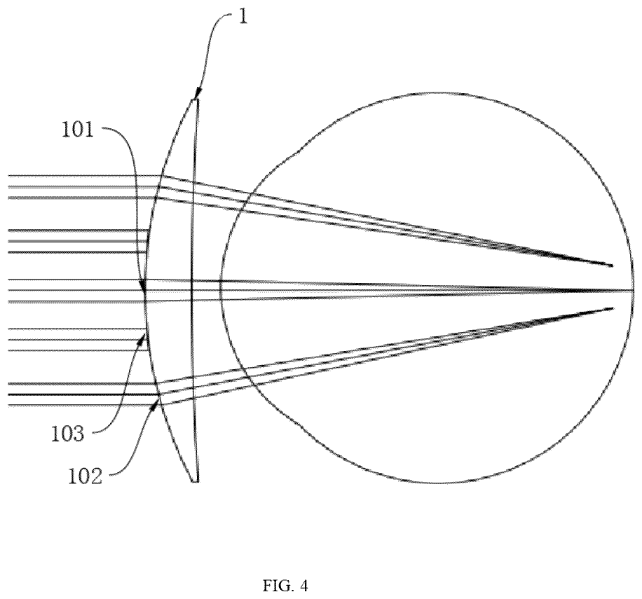

With reference to FIGS. 1-4, the present disclosure provides a technical solution: an eyeglass lens for preventing and controlling myopia includes a lens body 1, the lens body 1 includes a first area 101, a second area 102, and third areas 103. The first area 101 is a regular area formed with an optical centre of the lens body 1 as a centre, and the first area 101 has a refractive power with a myopia correction function. The second area 102 is a peripheral area of the lens body 1, and the second area 102 is used for focusing an image on a position in front of a retina of an eye, to inhibit myopia development of the eye. The third areas 103 are a plurality of island-shaped areas separate from one another on a portion of the lens body 1 between the first area 101 and the second area 102, and the third areas 103 are used for cutting off or scattering light passing through the areas so as to reduce a contrast of a retinal image, to inhibit a refractive error of the eye.

Each separate island-shaped area of the third areas 103 is in a symmetrical shape, and the symmetrical shape includes a circular shape. Each separate island-shaped area of the third areas 103 has a diameter of 1.0 mm, and spacing between adjacent separate island-shaped areas is 1.5 mm. The third areas 103 are formed at a front surface or a rear surface of the lens body 1. The third areas 103 form a regular area having the optical centre of the lens body 1 as a centre and having a diameter of 10 mm, and the regular area formed by the third areas 103 includes a shell shape. The third areas 103 cut off or scatter light by reducing a degree of finish of a surface so as to reduce the contrast of imaging on the retina.

An area of the third areas 103 is 25% of a sum of areas of the second area 102 and the third areas 103.

Refractive powers of the first area 101 and the second area 102 vary through the optical centre of the lens body 1 continuously and radially.

The first area 101 and the second area 102 obtain different refractive powers by forming different surface shapes. The first area 101 and the second area 102 includes a front surface and a rear surface of the lens body 1, either one or both of the front surface and the rear surface are free-form surfaces, and either one or both of the front surface and the rear surface include a horizontal meridian and a vertical meridian. The first area 101 and the second area 102 form a central area and a peripheral area, the central area is used for providing a positive refractive power for myopia correction, and the peripheral area includes a progressive area symmetrically distributed on two sides of the vertical meridian and radiating outward from the central area. The first area 101 and the second area 102 form an area having a feature point offset from the optical centre of the lens body 1 along the horizontal meridian by 20 mm, and the feature point has an additional refractive power of a refractive power being 1.00 D with respect to a correcting refractive power. The second area 102 has an additional refractive power with respect to the first area 101 for focusing the image on the position in front of the retina of the eye, to inhibit myopia development of the eye.

### Example 2

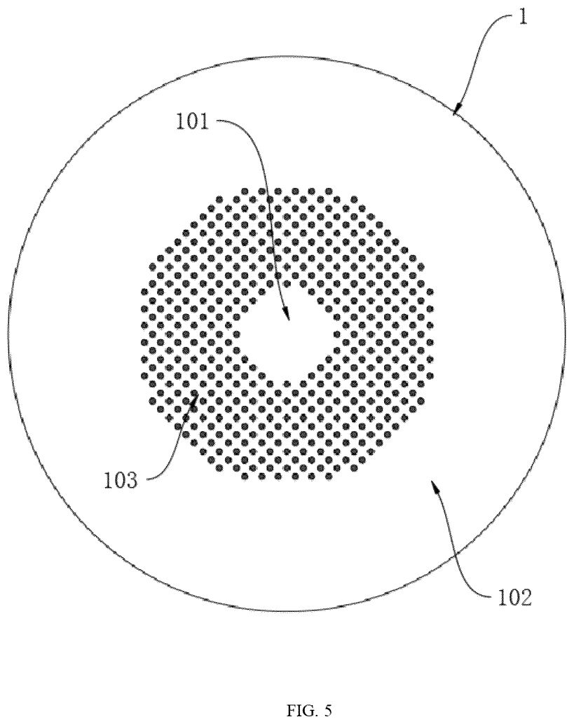

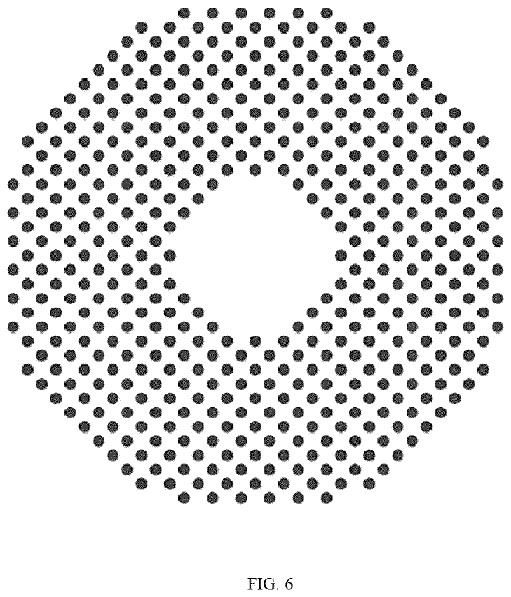

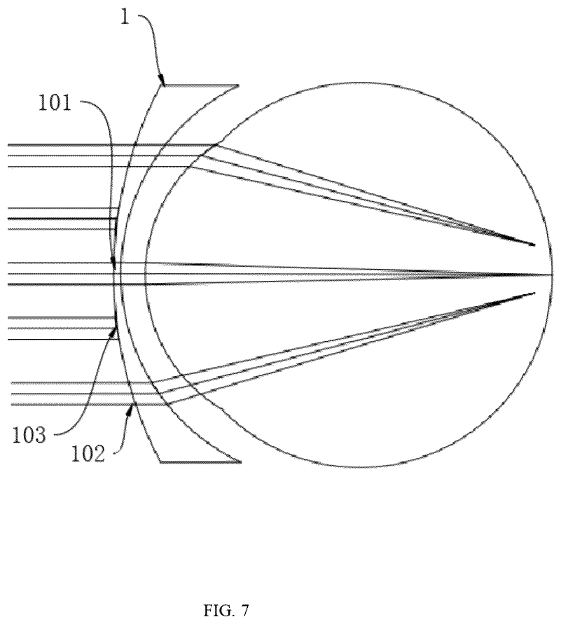

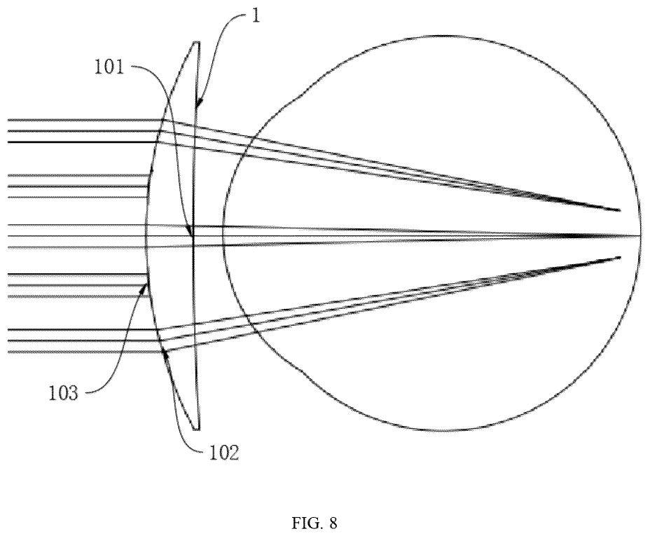

With reference to FIGS. 5-8, the present disclosure provides a technical solution: an eyeglass lens for preventing and controlling myopia includes a lens body 1, the lens body 1 includes a first area 101, a second area 102, and third areas 103. The first area 101 is a regular area formed with an optical centre of the lens body 1 as a centre, and the first area 101 has a refractive power with a myopia correction function. The second area 102 is a peripheral area of the lens body 1, and the second area 102 is used for focusing an image on a position in front of a retina of an eye, to inhibit myopia development of the eye. The third areas 103 are a plurality of island-shaped areas separate from one another on a portion of the lens body 1 between the first area 101 and the second area 102, and the third areas 103 are used for cutting off or scattering light passing through the areas so as to reduce a contrast of a retinal image, to inhibit a refractive error of the eye.

Each separate island-shaped area of the third areas 103 is in a symmetrical shape, and the symmetrical shape includes a circular shape. Each separate island-shaped area of the third areas 103 has a diameter of 1.5 mm, and spacing between adjacent separate island-shaped areas is 2.0 mm. The third areas 103 are formed at a front surface or a rear surface of the lens body 1. The third areas 103 form a regular area having the optical centre of the lens body 1 as a centre and having a diameter of 22 mm, and the regular area formed by the third areas 103 includes a regular octagon shape. The third areas 103 cut off or scatter light by reducing a degree of finish of a surface so as to reduce the contrast of imaging on the retina.

An area of the third areas 103 is 45% of a sum of areas of the second area 102 and the third areas 103.

Refractive powers of the first area 101 and the second area 102 vary through the optical centre of the lens body 1 continuously and radially. The first area 101 and the second area 102 obtain different refractive powers by forming different surface shapes. The first area 101 and the second area 102 includes a front surface and a rear surface of the lens body 1, either one or both of the front surface and the rear surface are free-form surfaces, and either one or both of the front surface and the rear surface include a horizontal meridian and a vertical meridian. The first area 101 and the second area 102 form a central area and a peripheral area, the central area is used for providing a positive refractive power for myopia correction, and the peripheral area includes a progressive area symmetrically distributed on two sides of the vertical meridian and radiating outward from the central area. The first area 101 and the second area 102 form an area having a feature point offset from the optical centre of the lens body 1 along the horizontal meridian by 20 mm, and the feature point has an additional refractive power of a refractive power being 1 D with respect to a correcting refractive power. The second area 102 has an additional refractive power with respect to the first area 101 for focusing the image on the position in front of the retina of the eye, to inhibit myopia development of the eye.

In the device, the lens body 1 includes a first area 101, a second area 102, and third areas 103. The first area 101 is a regular area formed with an optical centre of the lens body 1 as a centre, and the first area 101 has a refractive power with a myopia correction function. The second area 102 is a peripheral area of the lens body 1, and the second area 102 is used for focusing an image on a position in front of a retina of an eye, to inhibit myopia development of the eye. The third areas 103 are a plurality of island-shaped areas separate from one another on a portion of the lens body 1 between the first area 101 and the second area 102. While an image of an object formed in the first area 101 is visually distinguished, development of myopia is inhibited or at least slowed down by limiting imaging in front of the retina by the second area 102, and the development of myopia is further inhibited or at least slowed down by reducing a contrast of imaging at the periphery of the retina by the third area 103. The eyeglass lens has a function of inhibiting or at least slowing down development of myopia of a human eye, and a machining cost can be effectively controlled, to facilitate promotion and popularization of vision protective lenses.

It is to be noted that the relation terms, for example, first, second, etc., are used herein merely for distinguishing one entity or operation from another entity or operation but do not necessarily require or imply that there exists any actual relation or sequence between these entities or operations. Furthermore, terms “comprising”, “including” or any other variants are intended to cover the non-exclusive including, thereby making that the process, method, object or apparatus including a series of elements include not only those elements but also other elements that are not listed explicitly or the inherent elements to the process, method, object or apparatus.

Although examples of the present disclosure have been shown and described, it will be apparent to those of ordinary skill in the art that various changes, modifications, substitutions and variations may be made thereto without departing from the principles and spirit of the present disclosure, the scope of the present disclosure is defined by the appended claims and their equivalents.

What is claimed is:

1. An eyeglass lens for preventing and controlling myopia, comprising a lens body (1), wherein the lens body (1) comprises:
a first area (101), the first area (101) being a regular area formed with an optical centre of the lens body (1) as a centre, and the first area (101) having a refractive power with a myopia correction function;
a second area (102), the second area (102) being a peripheral area of the lens body (1), and the second area (102) being used for focusing an image on a position in front of a retina of an eye, to inhibit myopia development of the eye; and
third areas (103), the third areas (103) being a plurality of island-shaped areas separate from one another on a portion of the lens body (1) between the first area (101) and the second area (102), and the third areas (103) being used for cutting off or scattering light passing through the areas so as to reduce a contrast of a retinal image, to inhibit a refractive error of the eye.

2. The eyeglass lens for preventing and controlling myopia according to claim 1, wherein each separate island-shaped area of the third areas (103) is in a symmetrical shape, the symmetrical shape comprises a circular shape, a square shape and a regular hexagon shape, each separate island-shaped area of the third areas (103) has a diameter of 0.1 mm-2.0 mm, and spacing between adjacent separate island-shaped areas is 0.1 mm-3.0 mm.

3. The eyeglass lens for preventing and controlling myopia according to claim 1, wherein the third areas (103) are formed at a front surface or a rear surface of the lens body (1), the third areas (103) form a regular area having the optical centre of the lens body (1) as a centre and having a diameter of 5.0 mm-22 mm, and the regular area formed by the third areas (103) comprises a circular shape, a shell shape, a triangle shape, a square shape and a regular hexagon shape.

4. The eyeglass lens for preventing and controlling myopia according to claim 1, wherein the third areas (103) cut off or scatter light by reducing a degree of finish of a surface so as to reduce the contrast of imaging on the retina.

5. The eyeglass lens for preventing and controlling myopia according to claim 4, wherein an area of the third areas (103) is 10%-80% of a sum of areas of the second area (102) and the third areas (103).

6. The eyeglass lens for preventing and controlling myopia according to claim 1, wherein refractive powers of the first area (101) and the second area (102) vary through the optical centre of the lens body (1) continuously and radially.

7. The eyeglass lens for preventing and controlling myopia according to claim 1, wherein the first area (101) and the second area (102) obtain different refractive powers by forming different surface shapes.

8. The eyeglass lens for preventing and controlling myopia according to claim 1, wherein the first area (101) and the second area (102) comprise a front surface and a rear surface of the lens body (1), either one or both of the front surface and the rear surface are free-form surfaces, either one or both of the front surface and the rear surface comprise a horizontal meridian and a vertical meridian, and the first area (101) and the second area (102) form areas comprising:
a central area used for providing a positive refractive power for myopia correction; and
a peripheral area comprising a progressive area symmetrically distributed on two sides of the vertical meridian and radiating outward from the central area.

9. The eyeglass lens for preventing and controlling myopia according to claim 1, wherein the first area (101) and the second area (102) form an area having a feature point offset from the optical centre of the lens body (1) along a horizontal meridian by 20 mm, and the feature point has an additional refractive power of a refractive power being 0.40 D-2.00 D with respect to a correcting refractive power.

10. The eyeglass lens for preventing and controlling myopia according to claim 9, wherein the second area (102) has an additional refractive power with respect to the first area (101) for focusing the image on the position in front of the retina of the eye, to inhibit myopia development of the eye.
